(19) United States
(12) Patent Application Publication
(10) Pub. No.: US 2017/0017026 A1
(43) Pub. Date: Jan. 19, 2017

(54) POLARIZING PLATE, IMAGE DISPLAY DEVICE, AND LIQUID CRYSTAL DISPLAY DEVICE

(71) Applicant: FUJIFILM Corporation, Tokyo (JP)

(72) Inventor: Kotaro YASUDA, Kanagawa (JP)

(73) Assignee: FUJIFILM Corporation, Tokyo (JP)

(21) Appl. No.: 15/279,812

(22) Filed: Sep. 29, 2016

Related U.S. Application Data
(63) Continuation of application No. PCT/JP2015/059939, filed on Mar. 30, 2015.

(30) Foreign Application Priority Data
Mar. 31, 2014 (JP) 2014-074254

(51) Int. Cl. G02B 5/30; G02F 1/1335

(52) U.S. Cl. CPC G02B 5/3016; G02F 1/133528

(57) ABSTRACT

An object of the present invention is to provide a polarizing plate which is not easily curled by a change in environment, and an image display device and a liquid crystal display device including the polarizing plate. The polarizing plate of the present invention is a polarizing plate including a polarizer, a protective film, and a peeling film in this order, a modulus of elasticity of the peeling film is 2.0 GPa or more, and a thickness P [μm] of the polarizer, a thickness Q [μm] of the protective film, and a thickness T [μm] of the peeling film satisfy the following equation (A).

T≧(2.8×P−1.2×Q)+50 Equation (A)

### CROSS-REFERENCE TO RELATED APPLICATIONS

This application is a Continuation of PCT International Application No. PCT/JP2015/059939 filed on Mar. 30, 2015, which claims priority under 35 U.S.C. §119(a) to Japanese Patent Application No. 2014-074254 filed on Mar. 31, 2014. The above application is hereby expressly incorporated by reference, in its entirety, into the present application.

### BACKGROUND OF THE INVENTION

1. Field of the Invention

The present invention relates to a polarizing plate, an image display device, and a liquid crystal display device.

2. Description of the Related Art

Typically, a polarizer is produced by using a polyvinyl alcohol resin film. More specifically, a polarizer is produced by adsorbing and aligning a dichroic pigment such as iodine or a dichroic dye to a polyvinyl alcohol resin film and then uniaxially stretching the polyvinyl alcohol resin film.

Since such a polarizer is deteriorated in mechanical strength, a polarizer protective film (protective film) such as TAC (a film made of saponification-treated triacetyl cellulose) or the like is laminated on the polarizer and the laminate is used as a polarizing plate.

For example, JP2012-014148A discloses a polarizing plate including a polarizer and one polarizing plate protective film (claim 1, paragraph “0171”, and the like).

### SUMMARY OF THE INVENTION

Under these circumstances, when the present inventors have produced a polarizing plate including a polarizer and a protective film, referring to examples of JP2012-014148A, the obtained polarizing plate is curled by a change in environment (such as temperature and humidity) in some cases. When the polarizing plate is curled, lamination defects such as mixing of bubbles are easily generated in the case in which the polarizing plate is laminated on an adherend such as a liquid crystal cell, which is a problem.

In consideration of the above circumstances, an object of the present invention is to provide a polarizing plate which is not easily curled by a change in environment, and an image display device and a liquid crystal display device including the polarizing plate.

As a result of intensive investigation to achieve the above object, the present inventors have found that curling caused by a change in environment is prevented by using a peeling film having a specific modulus of elasticity and a specific thickness and thus have completed the present invention.

That is, the present inventors have found that the above problem can be solved by adopting the following configuration.

(1) A polarizing plate comprising, in this order: a polarizer; a protective film; and a peeling film,

wherein a modulus of elasticity of the peeling film is 2.0 GPa or more, and

a thickness P [μm] of the polarizer, a thickness Q [μm] of the protective film, and a thickness T [μm] of the peeling film satisfy the following equation (A).

T≧(2.8×P−1.2×Q)+50 Equation (A)

(2) The polarizing plate according to (1), wherein the modulus of elasticity of the peeling film is 3.0 GPa or more.

(3) The polarizing plate according to (1) or (2) further comprising: a liquid crystal layer,

wherein the polarizing plate includes the liquid crystal layer, the polarizer, the protective film, and the peeling film in this order.

(4) An image display device comprising:

the polarizing plate according to any one of (1) to (3); and

a display element.

(5) A liquid crystal display device comprising:

the polarizing plate according to any one of (1) to (3); and

a liquid crystal cell.

According to the present invention, it is possible to provide a polarizing plate which is not easily curled by a change in environment (that is, has excellent curling resistance) and an image display device and a liquid crystal display device including the polarizing plate.

### BRIEF DESCRIPTION OF THE DRAWINGS

FIG. 1 is a schematic sectional view showing a first embodiment of a polarizing plate of the present invention.

FIG. 2 is a schematic sectional view showing a second embodiment of a polarizing plate of the present invention.

FIG. 3 is a schematic sectional view showing a third embodiment of a polarizing plate of the present invention.

FIG. 4 is a schematic sectional view showing a fourth embodiment of a polarizing plate of the present invention.

FIG. 5 is a schematic sectional view showing a fifth embodiment of a polarizing plate of the present invention.

FIG. 6 is a schematic sectional view showing an embodiment (before a peeling film and an adhesive sheet are peeled off) of a liquid crystal display device of the present invention.

FIG. 7 is a schematic sectional view showing an embodiment (after a peeling film and an adhesive sheet are peeled off) of a liquid crystal display device of the present invention.

### DESCRIPTION OF THE PREFERRED EMBODIMENTS

Hereinafter, a polarizing plate, an image display device, and a liquid crystal display device of the present invention will be described.

In the present specification, a (meth)acryloyl group represents an acryloyl group or a methacryloyl group.

In addition, in the present specification, the numerical range which is shown by “to” using the present specification means the range including the numerical values described before and after the “to” as the minimum value and the maximum value, respectively.

[Polarizing Plate]

A polarizing plate of the present invention is a polarizing plate including a polarizer, a protective film, and a peeling film in this order. A modulus of elasticity of the peeling film is 2.0 GPa or more and a thickness P [μm] of the polarizer, a thickness Q [μm] of the protective film, and a thickness T [μm] of the peeling film satisfy an equation (A), which will be described later.

When the polarizing plate of the present invention adopts such a configuration, it is considered that the polarizing plate exhibits excellent curling resistance. Although not clear, the reason is assumed as follows.

The polarizing plate is a laminate composed of plural members (such as a polarizer and a protective film). Here, since each member constituting the polarizing plate has different thermal expansion coefficients and humidity line expansion coefficients thereof (humidity dimensional changes), in the case in which the environment to which the polarizing plate is exposed (such as temperature and humidity) changes, curling occurs due to different dimensional changes of each member. The problem caused by the curling of the polarizing plate is as described above.

As described above, the polarizing plate of the present invention includes a peeling film having a specific modulus of elasticity. Therefore, it is considered that even when the environment to which the polarizing plate is exposed changes, the above-described peeling film can prevent each member from dimensionally changing.

Further, since the thickness of the peeling film, the thickness of the polarizer, and the thickness of the protective film satisfy a specific relationship, stress generated inside the polarizing plate is extremely highly balanced. Here, the above specific relational expression is based on the findings that as the thickness of the polarizer increases, the thickness of the peeling film required for preventing curling increases, and in contrast, as the thickness of the protective film increases, the thickness of the peeling film required for preventing curling decreases, which are obtained from the investigation of the present inventors.

As a result, it is considered that the polarizing plate of the present invention prevents curling even when the environment to which the polarizing plate is exposed changes. This is assumed from the fact that in the case in which the thickness of the peeling film, the thickness of the polarizer, and the thickness of the protective film do not satisfy the specific relationship as shown in Comparative Examples (Comparative Examples 1 to 11), which are described later, insufficient curling resistance is exhibited in all Comparative Examples.

### First Embodiment

As a first embodiment of the polarizing plate of the present invention, there is a polarizing plate including a polarizer, a protective film, and a peeling film in this order. In addition, the peeling film is typically peeled off from the polarizing plate after the polarizing plate is laminated on an adherend.

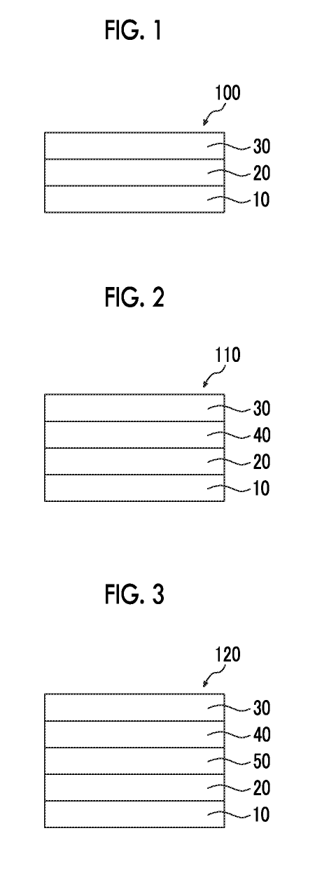

FIG. 1 is a schematic sectional view showing a polarizing plate 100 as a first embodiment of the polarizing plate of the present invention.

The polarizing plate 100 includes a polarizer 10, a protective film 20, and a peeling film 30 in this order.

Hereinafter, the polarizer, the protective film, and the peeling film will be described.

<Polarizer>

The polarizer may be any member as long as the member has a function of converting light into specific linearly polarized light, and for example, an absorption type polarizer, a reflective type polarizer, and the like may be used.

As the absorption type polarizer, an iodine polarizer, a dye polarizer using a dichroic dye, a polyethylene polarizer and the like may be used. The iodine polarizer and the dye polarizer include a coating type polarizer and a stretching type polarizer, and any of these may be applicable. A polarizer produced by adsorbing iodine or a dichroic dye to stretched polyvinyl alcohol is preferable.

As the reflective type polarizer, a polarizer obtained by laminating thin films having different birefringences, a wire grid type polarizer, a polarizer obtained by combining a cholesteric liquid crystal having a selective reflection area and a ¼ wavelength plate, and the like may be used.

Among these, from the viewpoint of achieving further excellent adhesiveness with the polarizer protective film which will be described later, a polarizer including a polyvinyl alcohol (PVA) resin (particularly, at least one selected from the group consisting of polyvinyl alcohols and ethylene-vinyl alcohol copolymers) is preferable.

The modulus of elasticity of the polarizer is not particularly limited and is preferably 1.0 to 20.0 GPa and more preferably 5.0 to 10.0 GPa.

In the present invention, the modulus of elasticity is a value in a direction in which maximum curling is obtained during measurement by changing a measurement direction with respect to samples by 45° and calculating the modulus of elasticity of each sample 8 times in the following manner, respectively. The evaluation method for curling is as described in “Evaluation of Curling Resistance”, which will be described later.

(Calculation Method of Modulus of Elasticity)

Each sample is cut so as to have a length of 150 mm in the measurement direction and a width of 10 mm, and immediately after being left in an environment at a temperature of 25° C. and a relative humidity of 60% for 24 hours, the sample is stretched with a full-automatic tensile tester: STROGRAPH R2 (manufactured by Toyo Seiki Co.) at an inter-chuck length of 100 mm and a stretch rate of 10 mm/min. A load at an elongation of 0.1% and a load at an elongation of 0.5% are measured and the modulus of elasticity is calculated from the inclination thereof.

The thickness of the polarizer is not particularly limited as long as the equation (A) which will be described later is satisfied. The thickness is preferably 1.0 to 50.0 μm, and within the above range, from the viewpoint of achieving further excellent curling resistance, the thickness is more preferably 2.0 to 20.0 μm and is still more preferably 3.0 to 10.0 μm.

<Protective Film>

The protective film is a film provided for protecting the above-described polarizer.

The material for the protective film is not particularly limited and examples thereof include cellulose polymers; acrylic polymers having acrylic ester polymers such as polymethyl methacrylate, and lactone ring-containing polymers; thermoplastic norbornene polymers; polycarbonate polymers; polyester polymers such as polyethylene terephthalate and polyethylene naphthalate; styrene polymers such as polystyrene and acrylonitrile-styrene copolymers (AS resin); polyolefin polymers such as polyethylene, polypropylene, and ethylene-propylene copolymers; vinyl chloride polymers; amide polymers such as nylon and aromatic polyamide; imide polymers; sulfone polymers; polyether sulfone polymers; polyether ether ketone polymers; polyphenylene sulfide polymers; vinylidene chloride polymers; vinyl alcohol polymers; vinyl butyral polymers; acrylate polymers; polyoxymethylene polymers; epoxy polymers; and polymers containing a mixture of these polymers.

In addition, the protective film may be formed as a cured layer of an ultraviolet curable resin such as acrylic resin, urethane resin, acrylic urethane resin, epoxy resin or silicone resin, or a thermosetting resin.

Among these, cellulose polymers which have been used as a known transparent protective film for a polarizing plate and are represented as triacetyl cellulose (hereinafter, also referred to as “cellulose acylate”) may be preferably used.

In addition, from the viewpoint of workability and optical performance, acrylic polymers are preferably used.

Examples of the acrylic polymers include polymethyl methacrylate or lactone ring-containing polymers described in paragraphs “0017” to “0107” of JP2009-98605A.

The modulus of elasticity of the protective film is not particularly limited and is preferably 1.0 to 20.0 GPa. Within this range, from the viewpoint of achieving further excellent curling resistance, the modulus of elasticity is more preferably 1.0 to 15.0 GPa, still more preferably 2.0 to 12.0 GPa, and particularly preferably 2.0 to 10.0 GPa. The measurement method of the modulus of elasticity is as described above.

The thickness of the protective film is not particularly limited as long as the equation (A) which will be described later is satisfied. The thickness is preferably 1.0 to 100.0 μm and within this range, from the viewpoint of achieving further excellent curling resistance, the thickness is more preferably 10.0 to 80.0 μm and still more preferably 10.0 to 40.0 μm.

The humidity dimensional change of the protective film is not particularly limited.

In the present specification, a humidity dimensional change is a value measured by the following manner.

That is, a sample having a length of 12 cm (in the measurement direction) and a width of 3 cm is prepared, and pin holes are perforated on the sample with intervals of 10 cm. Subsequently, humidity is controlled in an environment at 25° C. and a relative humidity of 10% for 6 hours, the intervals of the pin holes are measured with a pin gauge (the measured value is set to L₀). Next, the sample is humidity-controlled at 25° C. and a relative humidity of 80% for 6 hours and then the intervals of the pin holes are measured with a pin gauge (the measured value is set to L₁). These measured values are used to obtain a humidity dimensional change by the following equation.

Humidity dimensional change=(L₁−L₀)×100/L₀

In the case in which there is a difference in humidity dimensional change depending on the direction, a humidity dimensional change in a direction in which curling occurs is referred to as a humidity dimensional change.

<Peeling Film>

The peeling film is a layer provided on a principal surface on the opposite to a surface having the polarizer out of two principal surfaces of the protective film, and is closed attached to the protective film so as to be peelable. In second to fifth embodiments which will be described later, the peeling film adheres to the protective film through an adhesive layer so as to be peelable.

The peeling film is preferably a film whose surface is treated with a silicone release agent or another release agent or a film having its own peelability.

Examples of the material for constituting the peeling film include polyolefines such as polypropylene and polyethylene, polyesters (preferably a PET film), nylon, and polyvinyl chloride.

The thickness of the peeling film is not particularly limited as long as the equation (A) which will be described later is satisfied. The thickness is preferably 10.0 to 200.0 μm.

The modulus of elasticity of the peeling film is 2.0 GPa or more. Within this range, the modulus of elasticity is preferably 2.0 to 20.0 GPa and within the range, from the viewpoint of achieving further excellent curling resistance, the modulus of elasticity is more preferably 3.0 to 15.0 GPa and still more preferably 4.0 to 10.0 GPa. The measurement method of the modulus of elasticity is as described above.

<Relationship Among Thickness of Polarizer, Thickness Q of Protective Film, and Thickness of Peeling Film>

The thickness P [μm] of the polarizer, the thickness Q [μm] of the protective film, and the thickness T [μm] of the peeling film satisfy the following equation (A).

T≧(2.8×P−1.2×Q)+50 Equation (A)

In other words, the thickness T [μm] of the peeling film is equal to or greater than a value obtained by adding 50 to a value obtained by subtracting a value acquired by multiplying 1.2 by the thickness Q [μm] of the protective film from a value acquired by multiplying 2.8 by the thickness P [μm] of the polarizer. For example, in the case in which the thickness P of the polarizer is 5.0 μm and the thickness Q of the protective film is 25.0 μm, the thickness T [μm] of the peeling film is 34 [μm](=2.8×5.0 [μm]−1.2×25.0 [μm]+50).

The right side of the equation (A) is greater than 0. That is, (2.8×P−1.2×Q) is greater than −50.

In the case in which the thickness T [μm] of the peeling film does not satisfy the above equation (A), stress generated inside the polarizing plate is not balanced and as a result, curling resistance is not sufficient.

<Production Method>

A method of producing the polarizing plate according to the first embodiment is not particularly limited and a known method may be adopted. For example, a method of attaching a polarizer to one principal surface of a protective film using an adhesive (preferably a polyvinyl alcohol adhesive), and further attaching a peeling film to the other principal surface of the protective film may be used.

### Second Embodiment

A second embodiment of the polarizing plate of the present invention is a polarizing plate including a polarizer, a protective film, an adhesive layer, and a peeling film in this order. The polarizing plate of the present invention preferably includes an adhesive layer between the protective film and the peeling film similar to the second embodiment due to stable adhesion of the peeling film. The peeling film and the adhesive layer are typically peeled off from the polarizing plate after the polarizing plate is laminated on an adherend.

FIG. 2 is a schematic sectional view showing a polarizing plate 110 which is a second embodiment of the polarizing plate of the present invention.

The polarizing plate 110 includes a polarizer 10, a protective film 20, an adhesive layer 40, and a peeling film 30 in this order.

The polarizer, the protective film, and the peeling film are as described above.

The adhesive layer will be described below.

<Adhesive Layer>

The adhesive layer is a layer provided for improving adhesiveness between the protective film and the peeling film.

The material for the adhesive layer is not particularly limited and examples thereof include a rubber adhesive, an acrylic adhesive, a silicone adhesive, a urethane adhesive, a vinyl alkyl ether adhesive, a polyvinyl alcohol adhesive, a polyvinyl pyrrolidone adhesive, a polyacrylamide adhesive, and a cellulose adhesive.

Among these, from the viewpoint of transparency, weather fastness, and heat resistance, an acrylic adhesive is preferable.

<Production Method>

A method of producing the polarizing plate according to the second embodiment is not particularly limited and a known method may be adopted. For example, a method of attaching a polarizer to one principal surface of a protective film using an adhesive (preferably a polyvinyl alcohol adhesive), forming an adhesive layer on the other principal surface of the protective film, and further attaching a peeling film to the adhesive layer may be used.

A method of forming the adhesive layer is not particularly limited and for example, a method of applying an adhesive (adhesive layer forming composition), and then drying the adhesive may be used. The application method is not particularly limited and as specific methods, known methods such as a coating method using a double roll coater, a slit coater, an air knife coater, a wire bar coater, a slide hopper, spray coating, a blade coater, a doctor coater, a squeeze coater, a reverse roll coater, a transfer roll coater, an extrusion coater, a curtain coater, a dip coater, a die coater, or a gravure roll, an extrusion coating method, and a roll coating method may be used.

### Third Embodiment

As a third embodiment of the polarizing plate of the present invention, there is a polarizing plate including a polarizer, a protective film, a hard coat layer, an adhesive layer, and a peeling film in this order. The peeling film and the adhesive layer are typically peeled off from the polarizing plate after the polarizing plate is laminated to an adherend.

FIG. 3 is a schematic sectional view of a polarizing plate 120 which is a third embodiment of the polarizing plate of the present invention.

The polarizing plate 120 includes a polarizer 10, a protective film 20, a hard coat layer 50, an adhesive layer 40, and a peeling film 30 in this order.

The polarizer, the protective film, the adhesive layer, and the peeling film are as described above.

The hard coat layer will be described below.

<Hard Coat Layer>

The hard coat layer is a layer provided for mainly imparting physical strength to the polarizing plate.

The hard coat layer is preferably formed by a crosslinking reaction or a polymerization reaction of an ionizing radiation curable compound.

The ionizing radiation curable compound is not particularly limited and a photocurable compound is preferable. The photocurable compound is not particularly limited and examples thereof include monomers having an unsaturated polymerizable functional group such as a (meth)acryloyl group, a vinyl group, and an allyl group.

The thickness of the hard coat layer is not particularly limited but is preferably more than 0 μm and 20 μm or less and more preferably more than 0 μm and 10 μm or less.

<Production Method>

A method of producing the polarizing plate according to the third embodiment is not particularly limited and a known method may be adopted. For example, a method of laminating a polarizer on one principal surface of a protective film using an adhesive (preferably a polyvinyl alcohol adhesive), forming a hard coat layer on the other principal surface of the protective film, further attaching the adhesive layer to the formed hard coat layer, and further attaching a peeling layer to the formed adhesive layer may be used.

The method of forming the hard coat layer is not particularly limited and for example, a method of applying the above-described hard coat layer forming compound including an ionizing radiation curable compound and then photocuring the compound by ultraviolet irradiation may be used. Specific examples of the method of applying the hard coat layer forming composition are the same as the above-described examples of the method of applying the adhesive layer forming composition.

The method of forming the adhesive layer is the same as in the above-described second embodiment.

### Fourth Embodiment

As a fourth embodiment of the polarizing plate of the present invention, there is a polarizing plate including a liquid crystal cell, a polarizer, a protective film, an adhesive layer, and a peeling film in this order. The peeling film and the adhesive layer are typically peeled off from the polarizing plate after the polarizing plate is laminated on an adherend.

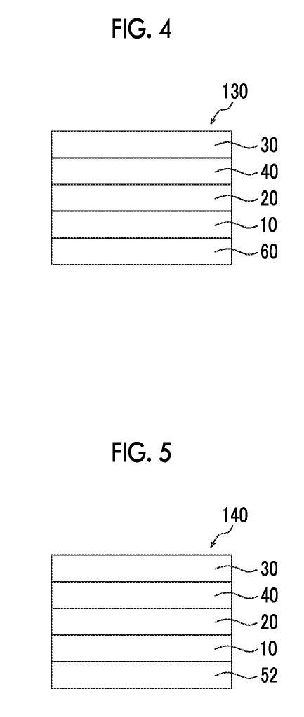

FIG. 4 is a schematic sectional view showing a polarizing plate 130 which is a fourth embodiment of the polarizing plate of the present invention.

The polarizing plate 130 includes a liquid crystal layer 60, a polarizer 10, a protective film 20, an adhesive layer 40, and a peeling film 30 in this order.

The polarizer, the protective film, the adhesive layer, and the peeling film are as described above.

Hereinafter, the liquid crystal layer will be described.

<Liquid Crystal Layer>

The liquid crystal layer is not particularly limited as long as the layer is a layer containing a liquid crystal compound. In the case in which the polarizing plate of the present invention is used for a liquid crystal display device, an optically anisotropic layer such as an optical compensation layer is preferable. An optical compensation layer is not particularly limited. In the case of a liquid crystal display device of a VA mode, a negative-C-plate and an A-plate, a negative-C-plate, and the like are preferably used. In the case of a liquid crystal display device of an IPS mode, a biaxial-plate, a positive-C-plate, and the like are preferably used. In the case in of a liquid crystal display device of a TN mode, a discotic hybrid aligned liquid crystal layer and the like are preferably used, and in the case of a liquid crystal display device of a STN mode, a biaxial-plate and the like are preferably used.

The thickness of the liquid crystal layer is not particularly limited and is preferably more than 0 μm and 20 μm or less and more preferably more than 0 μm and 10 μm or less.

<Production Method>

A method of producing the polarizing plate according to the fourth embodiment is not particularly limited and a known method may be adopted. For example, a method of attaching a polarizer to one principal surface of a protective film using an adhesive (preferably a polyvinyl alcohol adhesive), forming an adhesive layer on the other principal surface of the protective film, further attaching a peeling layer to the formed adhesive layer, and further forming a liquid crystal layer on the surface opposite to the principal surface to which the protective film of the polarizer is attached may be used.

The method of forming the liquid crystal layer is not particularly limited and a method of applying a composition including a liquid crystal compound, and then irradiating the compound with ultraviolet rays to fix the alignment state may be used.

The method of forming the adhesive layer is the same in the above-described second embodiment.

The fourth embodiment may include a hard coat layer between the protective film and the adhesive layer similar to the third embodiment.

### Fifth Embodiment

A fifth embodiment of the polarizing plate of the present invention is a polarizing plate including a hard coat layer, a polarizer, a protective layer, an adhesive layer, and a peeling film in this order. The peeling film and the adhesive layer are typically peeled off from the polarizing plate after the polarizing plate is laminated on an adherend.

FIG. 5 is a schematic sectional view of a polarizing plate 140 which is a fifth embodiment of the polarizing plate of the present invention.

The polarizing plate 140 includes a hard coat layer 52, a polarizer 10, a protective film 20, an adhesive layer 40, and a peeling film 30 in this order.

The hard coat layer, the polarizer, the protective film, the adhesive layer, and the peeling film are as described above.

<Production Method>

A method of producing the polarizing plate according to the fifth embodiment is not particularly limited and a known method may be adopted. For example, a method of laminating a polarizer on one principal surface of a protective film using an adhesive (preferably a polyvinyl alcohol adhesive), further forming an adhesive layer on the other principal surface of the protective film, further attaching a peeling film to the formed adhesive layer, and further forming a hard coat layer on the surface opposite to the principal surface to which the protective film of the polarizer is attached may be used.

The method of forming the adhesive layer is the same as in the above-described second embodiment.

The method of forming the hard coat layer is the same as in the above-described third embodiment.

The fifth embodiment may include a hard coat layer between the protective film and the adhesive layer similar to the third embodiment.

In the polarizing plate of the present invention, it is preferable that another protective film is not provided on the principal surface opposite to the principal surface on which the protective film is provided out of two principal surfaces of the polarizer from the viewpoint of reducing the thickness of the polarizing plate.

[Image Display Device]

An image display device of the present invention is an image display device having the above-described polarizing plate of the present invention and a display element (for example, a liquid crystal cell, an organic EL display panel, and the like).

[Display Element]

The display element used for the image display device of the present invention is not particularly limited and examples thereof include a liquid crystal cell, an organic EL display panel, and a plasma display panel.

Among these, a liquid crystal cell and an organic EL display panel are preferable, and a liquid crystal cell is more preferable. That is, as the image display device of the present invention, a liquid crystal display device using a liquid crystal cell as a display element, and an organic EL display device using an organic EL display panel as a display element are preferable and a liquid crystal display device is more preferable.

<Liquid Crystal Cell>

The liquid crystal cell used in the present invention is preferably a VA mode, an OCB mode, an IPS mode, or a TN mode but is not limited thereto.

In the liquid crystal cell of the TN mode, the rod-like liquid crystal molecules are aligned substantially horizontally when no voltage is applied, and furthermore twisted at 60 to 120°. The liquid crystal cell of the TN mode is most widely used as a color TFT liquid crystal display device, and described in many publications.

In the liquid crystalline cell of the VA mode, rod-like liquid crystal molecules are aligned substantially vertically when no voltage is applied. The liquid crystal cell of the VA mode, (1) a liquid crystal cell of the VA mode in a narrow definition in which rod-like liquid crystal molecules are aligned substantially vertically when no voltage is applied, and substantially horizontally when voltage is applied (described in JP1990-176625A (JP-H2-176625A)), (2) a liquid crystalline cell (in the MVA mode) for which the VA mode is made to have multi domains for view angle enlargement (described in SID97, Digest of Tech. Papers (Proceedings) 28 (1997) 845), (3) a liquid crystalline cell of a mode in which rod-like liquid crystal molecules are aligned substantially vertically when no voltage is applied, and twisted so as to be aligned into multi domains when voltage is applied (n-ASM mode) (described in the Proceedings of Japanese Liquid Crystal Society 58 to 59 (1998)), and (4) a liquid crystal cell of a survival mode (presented in the LCD International 98). In addition, the liquid crystal may have any of a patterned vertical alignment (PVA) type, an optical alignment type, and polymer-sustained alignment (PSA) type. The details of the above modes are described in JP2006-215326A and JP2008-538819A.

In the liquid crystal cell of the IPS mode, the rod-like liquid crystal molecules are aligned substantially in parallel to the substrate, and, when a parallel electric field is applied to the substrate surface, the liquid crystal molecules respond in a planar manner. The IPS mode displays black in an electric field-free state, and the absorption axes of a pair of top and bottom polarization plates cross orthogonally with each other. A method in which leaked light in an inclined direction while displaying black is reduced using an optical compensation sheet so as to improve the view angle is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), JP1998-307291A (JP-H10-307291A), and the like.

<Organic EL Display Panel>

The organic EL display panel used in the present invention is a display panel constituted using an organic EL element formed by sandwiching an organic light emitting layer (organic electroluminescent layer) between electrodes (between a cathode and an anode).

The constitution of the organic EL display panel is not particularly limited and a known constitution may be adopted.

As an organic EL display device which is an example of the image display device of the present invention, for example, an embodiment having the polarizing plate of the present invention, a plate having a λ/4 function (hereinafter, also referred to as “λ/4 plate”), and an organic EL display panel in this order from the visible side is preferably adopted.

Here, the “plate having a λ/4 function” refers to a plate having a function of converting linearly polarized light having a specific wavelength into circularly polarized light (or converting circularly polarized light into linearly polarized light), and for example, as an embodiment of a λ/4 plate having a single layer structure, specifically, a stretched polymer film and a phase difference film in which an optical anisotropic layer having a λ/4 function is provided on a support may be used. In addition, as an embodiment of the λ/4 plate having a multilayer structure, specifically, a broadband λ/4 plate formed by laminating a λ/4 plate and a λ/2 plate may be used.

[Liquid Crystal Display Device]

A liquid crystal display device of the present invention is a liquid crystal display device including the above-described polarizing plate and the above-described liquid crystal cell of the present invention. The liquid crystal cell is as described above.

In the present invention, it is preferable that the polarizing plate of the present invention is used for the polarizing plate of the front side, out of the polarizing plates provided the both sides of the liquid crystal cell, and it is more preferable that the polarizing plate of the present invention is used for the polarizing plates on the front and rear sides.

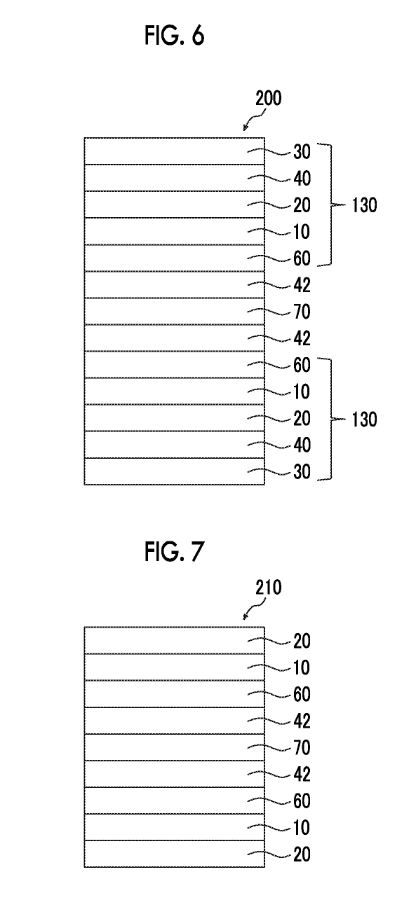

FIG. 6 is a schematic sectional view of a liquid crystal display device 200 which is an embodiment of the liquid crystal display device of the present invention.

The liquid crystal display device 200 has a liquid crystal cell 70, and polarizing plates 130 provided on both sides of the liquid crystal cell 70 through an adhesive layer 42. The polarizing plate 130 is the same as the above-described polarizing plate 130. In addition, the adhesive layer 42 is the same as the above-described adhesive layer. The liquid crystal cell 70 supports the liquid crystal layer between two electrode substrates (not shown).

The liquid crystal display device 200 is typically used in the form of an embodiment in which the peeling film 30 and the adhesive layer 40 are peeled off as shown in FIG. 7 (liquid crystal display device 210).

### EXAMPLES

The present invention is described with greater specificity below based on examples. The materials, amounts used, ratios, processing contents, processing procedures, and the like that are indicated in the examples below can be suitably modified without departing from the spirit of the present invention. Accordingly, the scope of the present invention should not be interpreted as being limited by the specific examples described below.

<Preparation of Peeling Film>

Polyethylene terephthalate was melted and extruded from a nozzle and then cooled and solidified on a casting drum at 25° C. Then, first, the film was heated by a roll heated to 110° C. and a radiation heater and stretched plural times such that the film was stretched by 4.8 times in the longitudinal direction and subsequently stretched by 4.1 times at 110° C. in the width direction using a tenter, and further a heat treatment (200° C.) was carried out in a heat treatment zone subsequent to the tenter to obtain a PET film (peeling film). Here, the thickness and the modulus of elasticity were respectively adjusted by changing the amount of extrusion and the stretching conditions and thus the following peeling films 1 to 15 were obtained.
Peeling film 1: PET film (thickness: 20.0 μm, modulus of elasticity: 2.2 GPa)
Peeling film 2: PET film (thickness: 40.0 μm, modulus of elasticity: 2.2 GPa)
Peeling film 3: PET film (thickness: 60.0 μm, modulus of elasticity: 2.2 GPa)
Peeling film 4: PET film (thickness: 20.0 μm, modulus of elasticity: 5.2 GPa)
Peeling film 5: PET film (thickness: 30.0 μm, modulus of elasticity: 5.2 GPa)
Peeling film 6: PET film (thickness: 40.0 μm, modulus of elasticity: 5.2 GPa)
Peeling film 7: PET film (thickness: 50.0 μm, modulus of elasticity: 5.2 GPa)
Peeling film 8: PET film (thickness: 60.0 μm, modulus of elasticity: 5.2 GPa)
Peeling film 9: PET film (thickness: 70.0 μm, modulus of elasticity: 5.2 GPa)
Peeling film 10: PET film (thickness: 80.0 μm, modulus of elasticity: 5.2 GPa)
Peeling film 11: PET film (thickness: 90.0 μm, modulus of elasticity: 5.2 GPa)
Peeling film 12: PET film (thickness: 110.0 μm, modulus of elasticity: 5.2 GPa)
Peeling film 13: PET film (thickness: 20.0 μm, modulus of elasticity: 8.2 GPa)
Peeling film 14: PET film (thickness: 40.0 μm, modulus of elasticity: 8.2 GPa)
Peeling film 15: PET film (thickness: 60.0 μm, modulus of elasticity: 8.2 GPa)

<Preparation of Protective Film (Protective Films 1, and 3 to 8)>

1. Preparation of Core Layer Cellulose Acrylate Solution

The following “components of core layer cellulose acrylate solution” were put into a mixer and dissolved under stirring to prepare a core layer cellulose acrylate solution.

(Components of Core Layer Cellulose Acrylate Solution)
Cellulose acylate having an acetyl substitution degree of 2.88 (100 parts by mass)
Ester oligomer L (dicarboxylic acid:phthalic acid, diol:ethylene glycol, terminal: acetyl group, hydroxyl value: 0 mg KOH/g, molecular weight: 650) (10 parts by mass)
Polarizer durability improver (2-3) (having the following structure) (4 parts by mass)
Ultraviolet absorbent U (having the following structure) (2 parts by mass)
Methylene chloride (first solvent) (430 parts by mass)
Methanol (second solvent) (64 parts by mass)

(Polarizer Durability Improver (2-3))

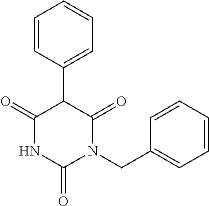 [SMILES: O=C1NC(=O)N(Cc2ccccc2)C(=O)C1c1ccccc1]

(Ultraviolet Absorbent U)

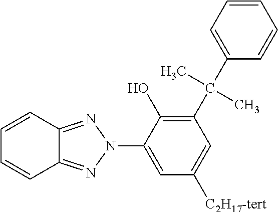

2. Preparation of Outer layer Cellulose Acrylate Solution

To 90 parts by mass of the core layer cellulose acrylate solution, 10 parts by mass of a matting agent solution composed of the following “components of matting agent solution” was added to obtain an outer layer cellulose acrylate solution.

(Components of Matting Agent Solution)
Silica particles having an average particle size of 20 nm (AEROSIL R972, produced by Nippon Aerosil Co., Ltd.) (2 parts by mass)
Methylene chloride (first solvent) (76 parts by mass)
Methanol (second solvent) (11 parts by mass)
Dope of core layer cellulose acrylate solution above (1 part by mass)

3. Preparation of Protective Film

Three layers of the core layer cellulose acrylate solution and the outer layer cellulose acrylate solution on both sides thereof were cast on the drum at 20° C. from casting ports at the same time. In a state in which the solvent content reached about 20% by mass, the film was peeled off and the both ends of the film in the width direction were fixed by a tenter clip. In a state in which the amount of the residual solvent was 3 to 15% by mass, the film was dried while being stretched by 1.1 times in the horizontal direction. Then, the stretched film was conveyed between rolls in a heat treatment device and further dried. Thus, a cellulose acylate film having a thickness of 40 μm was prepared (Protective film 5). In addition, the amount of casting was adjusted to prepare cellulose acylate films each having thicknesses of 25 μm (Protective film 4) and 5 μm (Protective film 3). When the modulus of elasticity of each of Protective films 3 to 5 in the horizontal direction was measured, the modulus of elasticity was 5.7 GPa.

Further, a cellulose acylate film (Protective film 1) having a thickness of 25 μm, a modulus of elasticity of 2.7 GPa in the horizontal direction, and a humidity dimensional change of 0.2%, a cellulose acylate film (Protective film 7) having a thickness of 25 μm, a modulus of elasticity of 2.7 GPa in the horizontal direction, and a humidity dimensional change of 0.0%, a cellulose acylate film (Protective film 6) having a thickness of 25 μm, a modulus of elasticity of 8.7 GPa in the horizontal direction, and a humidity dimensional change of 0.2%, and a cellulose acylate film (Protective film 8) having a thickness of 25 μm, a modulus of elasticity of 8.7 GPa in the horizontal direction, and a humidity dimensional change of 0.4% were prepared by appropriately adjusting the amount of casting and the stretching conditions.

The above-described modulus of elasticity in the horizontal direction corresponds to a modulus of elasticity in a direction in which the amount of curling is great in the section of “Evaluation of Curling Resistance”, which will be described later.

<Preparation of Protective Film 2>

90 parts by mass of (meth)acrylic resin (mass ratio of copolymerizable monomers=methyl methacrylate/2-(hydroxymethyl)methyl acrylate=8/2, lactone cyclization ratio: about 100%, content of lactone ring structure: 19.4%, mass average molecular weight: 133,000, melt flow rate: 6.5 g/10 min (240° C., 10 kgf), Tg: 131° ° C. having a lactone ring structure represented by the following formula (1) (herein, R¹ represents a hydrogen atom and R² and R³ represent a methyl group), and 10 parts by mass of acrylonitrile-styrene (AS) resin (TOYO AS AS20, produced by Toyo-Styrene Co., Ltd.) were mixed with each other to obtain a mixture (Tg: 127° C.) as a pellet. This pellet was supplied to a twin screw extruder and was extruded into a sheet shape at about 280° C. As a result, a (meth)acrylic resin sheet having a thickness of 110 μm which has a lactone ring structure was obtained. This unstretched sheet was stretched by 2.0 times in the vertical direction and 2.4 times in the horizontal direction under a temperature condition of 160° C., thereby obtaining an acrylic resin film (thickness: 20 μm, modulus of elasticity: 3.3 GPa). The obtained acrylic resin film was used as Protective film 2.

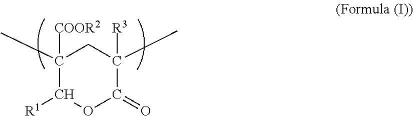

<Preparation of Polarizer 1>

According to the method described in JP4804588B, a thin film polarizer was prepared as described below. Specifically, first, isophthalic acid copolymerized polyethylene terephthalate in which 6 mol % of isophthalic acid was copolymerized was prepared as an amorphous ester thermoplastic resin substrate. A PVA resin layer was formed on this resin substrate. The resin substrate and the PVA resin layer were stretched together through a two-step stretching process of auxiliary stretching in air and stretching in boric-acid solution. The PVA resin layer was subjected to a dying treatment with a dichroic pigment and then the amorphous ester thermoplastic resin substrate was peeled off. Thus, a polarizer was produced. The obtained polarizer was used as Polarizer 1. The thickness of Polarizer 1 was 5.0 μm. In addition, the modulus of elasticity was 6.8 GPa. The evaluation method of modulus of elasticity is as described above.

<Preparation of Polarizer 2>

A polyvinyl alcohol film was stretched by about 6 times in warm water at 40° C. This film was immersed in an aqueous solution containing iodine (0.5 g/l) and potassium iodide (50 g/l) at 30° C. for 1 hour. Next, the film was immersed in an aqueous solution containing boric acid (100 g/l) and potassium iodide (60 g/l) at 70° C. for 5 minutes. Further, the film was film was washed with water in a water washing vessel at 20° C. for 10 seconds, and dried at 80° C. for 5 minutes to obtain an iodine polarizer. The obtained iodine polarizer was used as Polarizer 2. The thickness of Polarizer 2 was 15.0 μm.

In addition, the modulus of elasticity was 6.8 GPa. The evaluation method of the modulus of elasticity is as described above.

<Preparation of Polarizer 3>

An iodine polarizer was obtained in the same procedure as the procedure of the preparation of Polarizer 2 except that the thickness of the polyvinyl alcohol film to be used was changed. The obtained iodine polarizer was used as Polarizer 3. The thickness of Polarizer 3 was 30.0 μm. In addition, the modulus of elasticity was 6.8 GPa. The evaluation method of the modulus of elasticity is as described above.

<Preparation of Adhesive Coating Solution>

96.5 parts by mass of butyl acrylate, 3 parts by mass of acrylic acid, 0.5 parts by mass of 2-hydroxyethyl acrylate, 0.15 parts by mass of 2,2′-azobis isobutyrate nitrile, and 100 parts by mass of ethyl acetate were put and purging with nitrogen was sufficiently carried out. Then, the materials were allowed to react under a nitrogen stream at 60° C. for 8 hours while stirring, and thus an acrylic polymer solution having a weight average molecular weight of 1,650,000 was obtained. With respect to 100 parts by mass of the solid content of the acrylic polymer solution, 0.5 parts by mass of an isocyanate cross-linking agent (CORONATE L, produced by Nippon Polyurethane Co., Ltd.) was mixed and thus ah adhesive coating solution (solid content: 12%) was prepared.

### Example 1

Polarizer 1 was attached to one principal surface of Protective film 3 (cellulose acrylate film having a thickness of 5.0 μm and a modulus of elasticity of 5.7 GPa) using a polyvinyl alcohol adhesive.

Next, the adhesive coating solution obtained above was applied to Peeling film 8 prepared above (PET film having a thickness of 60.0 μm and a modulus of elasticity of 5.2 GPa) using a die coater such that the thickness when dried was 20 μm and then was subjected to a first drying process of blowing air in an oven at 70° C. at an air blowing rate of 14 m/sec for 1 minute. Next, a second drying process of blowing air at a temperature of 155° C. and an air blowing rate of 15 m/sec for 2 minutes was carried out to form an adhesive layer.

Next, the surface of the adhesive layer opposite to Peeling film 8 was laminated on the surface of Protective film 3 to which Polarizer 1 was attached as described above and which was opposite to the Polarizer 1. In this manner, a polarizing plate including the polarizer, the protective film, the adhesive layer, and the peeling film in this order was obtained.

### Examples 2 to 24 and Comparative Examples 1 to 11

Each polarizing plate including a polarizer, a protective film, an adhesive layer, and a peeling film in this order was obtained in the same procedure as in Example 1 except that a polarizer (marked with a circle in First table) shown in First table was used instead of Polarizer 1, a protective film (marked with a circle in First table) marked with a circle in First table was used instead of Protective film 3, and a peeling film (marked with a circle in First table) shown in First table was used instead of Peeling film 8.

TABLE 1

| | | | Modulus | | | | | | | | | | |
|---|---|---|---|---|---|---|---|---|---|---|---|---|---|
| | | Thick- | of | Humidity | Com- | | | Com- | | | Com- | | |
| | | ness | elasticity | dimensional | parative | Exam- | Exam- | parative | Exam- | Exam- | parative | Exam- | Exam- |
| First table (Part 1) | | [μm] | [GPa] | change (%) | Example 1 | ple 1 | ple 2 | Example 2 | ple 3 | ple 4 | Example 3 | ple 5 | ple 6 |
| Peeling | Peeling | 20.0 | 2.2 | | | | | | | | | | |
| film | film 1 | | | | | | | | | | | | |
| | Peeling | 40.0 | 2.2 | | | | | | | | | | |
| | film 2 | | | | | | | | | | | | |
| | Peeling | 60.0 | 2.2 | | | | | | | | | | |
| | film 3 | | | | | | | | | | | | |
| | Peeling | 20.0 | 5.2 | | | | | ◯ | | | | | |
| | film 4 | | | | | | | | | | | | |
| | Peeling | 30.0 | 5.2 | | | | | | | | | | |
| | film 5 | | | | | | | | | | | | |
| | Peeling | 40.0 | 5.2 | | ◯ | | | | ◯ | | | | |
| | film 6 | | | | | | | | | | | | |
| | Peeling | 50.0 | 5.2 | | | | | | | | ◯ | | |
| | film 7 | | | | | | | | | | | | |
| | Peeling | 60.0 | 5.2 | | | ◯ | | | | ◯ | | | |
| | film 8 | | | | | | | | | | | | |
| | Peeling | 70.0 | 5.2 | | | | | | | | | ◯ | |
| | film 9 | | | | | | | | | | | | |
| | Peeling | 80.0 | 5.2 | | | | ◯ | | | | | | |
| | film 10 | | | | | | | | | | | | |
| | Peeling | 90.0 | 5.2 | | | | | | | | | | ◯ |
| | film 11 | | | | | | | | | | | | |
| | Peeling | 110.0 | 5.2 | | | | | | | | | | |
| | film 12 | | | | | | | | | | | | |
| | Peeling | 20.0 | 8.2 | | | | | | | | | | |
| | film 13 | | | | | | | | | | | | |
| | Peeling | 40.0 | 8.2 | | | | | | | | | | |
| | film 14 | | | | | | | | | | | | |
| | Peeling | 60.0 | 8.2 | | | | | | | | | | |
| | film 15 | | | | | | | | | | | | |
| Pro- | Protective | 25.0 | 2.7 | 0.2 | | | | | | | | | |
| tective | film 1 | | | | | | | | | | | | |
| film | Protective | 20.0 | 3.3 | | | | | | | | | | |
| | film 2 | | | | | | | | | | | | |
| | Protective | 5.0 | 5.7 | | ◯ | ◯ | ◯ | | | | | | |
| | film 3 | | | | | | | | | | | | |
| | Protective | 25.0 | 5.7 | | | | | ◯ | ◯ | ◯ | ◯ | ◯ | ◯ |
| | film 4 | | | | | | | | | | | | |
| | Protective | 40.0 | 5.7 | | | | | | | | | | |
| | film 5 | | | | | | | | | | | | |
| | Protective | 25.0 | 8.7 | 0.2 | | | | | | | | | |
| | film 6 | | | | | | | | | | | | |
| | Protective | 25.0 | 2.7 | 0.0 | | | | | | | | | |
| | film 7 | | | | | | | | | | | | |
| | Protective | 25.0 | 8.7 | 0.4 | | | | | | | | | |
| | film 8 | | | | | | | | | | | | |
| Polar- | Polarizer 1 | 5.0 | 6.8 | | ◯ | ◯ | ◯ | ◯ | ◯ | ◯ | | | |
| izer | Polarizer 2 | 15.0 | 6.8 | | | | | | | | ◯ | ◯ | ◯ |
| | Polarizer 3 | 30.0 | 6.8 | | | | | | | | | | |

TABLE 2

| | | | Modulus | | | | | | | |
|---|---|---|---|---|---|---|---|---|---|---|
| | | | of | Humidity | | | | | | |
| | | Thickness | elasticity | dimensional | Comparative | | | Comparative | | Example |
| First table (Part 2) | | [μm] | [GPa] | change (%) | Example 4 | Example 7 | Example 8 | Example 5 | Example 9 | 10 |
| Peeling | Peeling | 20.0 | 2.2 | | | | | | | |
| film | film 1 | | | | | | | | | |
| | Peeling | 40.0 | 2.2 | | | | | | | |
| | film 2 | | | | | | | | | |
| | Peeling | 60.0 | 2.2 | | | | | | | |
| | film 3 | | | | | | | | | |
| | Peeling | 20.0 | 5.2 | | | | | | | |
| | film 4 | | | | | | | | | |
| | Peeling | 30.0 | 5.2 | | ◯ | | | | | |
| | film 5 | | | | | | | | | |
| | Peeling | 40.0 | 5.2 | | | | | | | |
| | film 6 | | | | | | | | | |
| | Peeling | 50.0 | 5.2 | | | ◯ | | | | |
| | film 7 | | | | | | | | | |
| | Peeling | 60.0 | 5.2 | | | | | ◯ | | |
| | film 8 | | | | | | | | | |
| | Peeling | 70.0 | 5.2 | | | | ◯ | | | |
| | film 9 | | | | | | | | | |
| | Peeling | 80.0 | 5.2 | | | | | | | |
| | film 10 | | | | | | | | | |
| | Peeling | 90.0 | 5.2 | | | | | | ◯ | |
| | film 11 | | | | | | | | | |
| | Peeling | 110.0 | 5.2 | | | | | | | ◯ |
| | film 12 | | | | | | | | | |
| | Peeling | 20.0 | 8.2 | | | | | | | |
| | film 13 | | | | | | | | | |
| | Peeling | 40.0 | 8.2 | | | | | | | |
| | film 14 | | | | | | | | | |
| | Peeling | 60.0 | 8.2 | | | | | | | |
| | film 15 | | | | | | | | | |
| Protective | Protective | 25.0 | 2.7 | 0.2 | | | | | | |
| film | film 1 | | | | | | | | | |
| | Protective | 20.0 | 3.3 | | | | | | | |
| | film 2 | | | | | | | | | |
| | Protective | 5.0 | 5.7 | | | | | | | |
| | film 3 | | | | | | | | | |
| | Protective | 25.0 | 5.7 | | | | | | | |
| | film 4 | | | | | | | | | |
| | Protective | 40.0 | 5.7 | | ◯ | ◯ | ◯ | ◯ | ◯ | ◯ |
| | film 5 | | | | | | | | | |
| | Protective | 25.0 | 8.7 | 0.2 | | | | | | |
| | film 6 | | | | | | | | | |
| | Protective | 25.0 | 2.7 | 0.0 | | | | | | |
| | film 7 | | | | | | | | | |
| | Protective | 25.0 | 8.7 | 0.4 | | | | | | |
| | film 8 | | | | | | | | | |
| Polarizer | Polarizer 1 | 5.0 | 6.8 | | | | | | | |
| | Polarizer 2 | 15.0 | 6.8 | | ◯ | ◯ | ◯ | | | |
| | Polarizer 3 | 30.0 | 6.8 | | | | | ◯ | ◯ | ◯ |

TABLE 3

| | | | Modulus of | Humidity | | | | | | |
|---|---|---|---|---|---|---|---|---|---|---|
| | | Thickness | elasticity | dimensional | Comparative | | | Comparative | | |
| First table (Part 3) | | [μm] | [GPa] | change (%) | Example 6 | Example 11 | Example 12 | Example 7 | Example 13 | Example 14 |
| Peeling | Peeling | 20.0 | 2.2 | | ◯ | | | | | |
| film | film 1 | | | | | | | | | |
| | Peeling | 40.0 | 2.2 | | | ◯ | | | | |
| | film 2 | | | | | | | | | |
| | Peeling | 60.0 | 2.2 | | | | ◯ | | | |
| | film 3 | | | | | | | | | |
| | Peeling | 20.0 | 5.2 | | | | | | | |
| | film 4 | | | | | | | | | |
| | Peeling | 30.0 | 5.2 | | | | | | | |
| | film 5 | | | | | | | | | |
| | Peeling | 40.0 | 5.2 | | | | | | | |
| | film 6 | | | | | | | | | |
| | Peeling | 50.0 | 5.2 | | | | | | | |
| | film 7 | | | | | | | | | |
| | Peeling | 60.0 | 5.2 | | | | | | | |
| | film 8 | | | | | | | | | |
| | Peeling | 70.0 | 5.2 | | | | | | | |
| | film 9 | | | | | | | | | |
| | Peeling | 80.0 | 5.2 | | | | | | | |
| | film 10 | | | | | | | | | |
| | Peeling | 90.0 | 5.2 | | | | | | | |
| | film 11 | | | | | | | | | |
| | Peeling | 110.0 | 5.2 | | | | | | | |
| | film 12 | | | | | | | | | |
| | Peeling | 20.0 | 8.2 | | | | | ◯ | | |
| | film 13 | | | | | | | | | |
| | Peeling | 40.0 | 8.2 | | | | | | ◯ | |
| | film 14 | | | | | | | | | |
| | Peeling | 60.0 | 8.2 | | | | | | | ◯ |
| | film 15 | | | | | | | | | |
| Protective | Protective | 25.0 | 2.7 | 0.2 | | | | | | |
| film | film 1 | | | | | | | | | |
| | Protective | 20.0 | 3.3 | | | | | | | |
| | film 2 | | | | | | | | | |
| | Protective | 5.0 | 5.7 | | | | | | | |
| | film 3 | | | | | | | | | |
| | Protective | 25.0 | 5.7 | | ◯ | ◯ | ◯ | ◯ | ◯ | ◯ |
| | film 4 | | | | | | | | | |
| | Protective | 40.0 | 5.7 | | | | | | | |
| | film 5 | | | | | | | | | |
| | Protective | 25.0 | 8.7 | 0.2 | | | | | | |
| | film 6 | | | | | | | | | |
| | Protective | 25.0 | 2.7 | 0.0 | | | | | | |
| | film 7 | | | | | | | | | |
| | Protective | 25.0 | 8.7 | 0.4 | | | | | | |
| | film 8 | | | | | | | | | |
| Polarizer | Polarizer 1 | 5.0 | 6.8 | | ◯ | ◯ | ◯ | ◯ | ◯ | ◯ |
| | Polarizer 2 | 15.0 | 6.8 | | | | | | | |
| | Polarizer 3 | 30.0 | 6.8 | | | | | | | |

TABLE 4

| | | | Modulus | | | | | | | | | |
|---|---|---|---|---|---|---|---|---|---|---|---|---|
| | | | of | Humidity | Com- | | | | | | | |
| | | Thickness | elasticity | dimensional | parative | Exam- | Exam- | Exam- | Exam- | Comparative | Example | Example |
| First table (Part 4) | | [μm] | [GPa] | change (%) | Example 8 | ple 15 | ple 16 | ple 17 | ple 18 | Example 9 | 19 | 20 |
| Peeling | Peeling | 20.0 | 2.2 | | | | | | | | | |
| film | film 1 | | | | | | | | | | | |
| | Peeling | 40.0 | 2.2 | | | | | | | | | |
| | film 2 | | | | | | | | | | | |
| | Peeling | 60.0 | 2.2 | | | | | | | | | |
| | film 3 | | | | | | | | | | | |
| | Peeling | 20.0 | 5.2 | | ◯ | | | | | | | |
| | film 4 | | | | | | | | | | | |
| | Peeling | 30.0 | 5.2 | | | | | | | ◯ | | |
| | film 5 | | | | | | | | | | | |
| | Peeling | 40.0 | 5.2 | | | ◯ | | ◯ | | | | |
| | film 6 | | | | | | | | | | | |
| | Peeling | 50.0 | 5.2 | | | | | | | | ◯ | |
| | film 7 | | | | | | | | | | | |
| | Peeling | 60.0 | 5.2 | | | | ◯ | | ◯ | | | |
| | film 8 | | | | | | | | | | | |
| | Peeling | 70.0 | 5.2 | | | | | | | | | ◯ |
| | film 9 | | | | | | | | | | | |
| | Peeling | 80.0 | 5.2 | | | | | | | | | |
| | film 10 | | | | | | | | | | | |
| | Peeling | 90.0 | 5.2 | | | | | | | | | |
| | film 11 | | | | | | | | | | | |
| | Peeling | 110.0 | 5.2 | | | | | | | | | |
| | film 12 | | | | | | | | | | | |
| | Peeling | 20.0 | 8.2 | | | | | | | | | |
| | film 13 | | | | | | | | | | | |
| | Peeling | 40.0 | 8.2 | | | | | | | | | |
| | film 14 | | | | | | | | | | | |
| | Peeling | 60.0 | 8.2 | | | | | | | | | |
| | film 15 | | | | | | | | | | | |
| Protective | Protective | 25.0 | 2.7 | 0.2 | ◯ | ◯ | ◯ | | | | | |
| film | film 1 | | | | | | | | | | | |
| | Protective | 20.0 | 3.3 | | | | | | | ◯ | ◯ | ◯ |
| | film 2 | | | | | | | | | | | |
| | Protective | 5.0 | 5.7 | | | | | | | | | |
| | film 3 | | | | | | | | | | | |
| | Protective | 25.0 | 5.7 | | | | | | | | | |
| | film 4 | | | | | | | | | | | |
| | Protective | 40.0 | 5.7 | | | | | | | | | |
| | film 5 | | | | | | | | | | | |
| | Protective | 25.0 | 8.7 | 0.2 | | | | ◯ | ◯ | | | |
| | film 6 | | | | | | | | | | | |
| | Protective | 25.0 | 2.7 | 0.0 | | | | | | | | |
| | film 7 | | | | | | | | | | | |
| | Protective | 25.0 | 8.7 | 0.4 | | | | | | | | |
| | film 8 | | | | | | | | | | | |
| Polarizer | Polarizer 1 | 5.0 | 6.8 | | ◯ | ◯ | ◯ | ◯ | ◯ | ◯ | ◯ | ◯ |
| | Polarizer 2 | 15.0 | 6.8 | | | | | | | | | |
| | Polarizer 3 | 30.0 | 6.8 | | | | | | | | | |

TABLE 5

| | | | Modulus of | Humidity | | | | | | |
|---|---|---|---|---|---|---|---|---|---|---|
| | | Thickness | elasticity | dimensional | Comparative | | | Comparative | | |
| First table (Part 5) | | [μm] | [GPa] | change (%) | Example 10 | Example 21 | Example 22 | Example 11 | Example 23 | Example 24 |
| Peeling | Peeling | 20.0 | 2.2 | | | | | | | |
| film | film 1 | | | | | | | | | |
| | Peeling | 40.0 | 2.2 | | | | | | | |
| | film 2 | | | | | | | | | |
| | Peeling | 60.0 | 2.2 | | | | | | | |
| | film 3 | | | | | | | | | |
| | Peeling | 20.0 | 5.2 | | ◯ | | | ◯ | | |
| | film 4 | | | | | | | | | |
| | Peeling | 30.0 | 5.2 | | | | | | | |
| | film 5 | | | | | | | | | |
| | Peeling | 40.0 | 5.2 | | | ◯ | | | ◯ | |
| | film 6 | | | | | | | | | |
| | Peeling | 50.0 | 5.2 | | | | | | | |
| | film 7 | | | | | | | | | |
| | Peeling | 60.0 | 5.2 | | | | ◯ | | | ◯ |
| | film 8 | | | | | | | | | |
| | Peeling | 70.0 | 5.2 | | | | | | | |
| | film 9 | | | | | | | | | |
| | Peeling | 80.0 | 5.2 | | | | | | | |
| | film 10 | | | | | | | | | |
| | Peeling | 90.0 | 5.2 | | | | | | | |
| | film 11 | | | | | | | | | |
| | Peeling | 110.0 | 5.2 | | | | | | | |
| | film 12 | | | | | | | | | |
| | Peeling | 20.0 | 8.2 | | | | | | | |
| | film 13 | | | | | | | | | |
| | Peeling | 40.0 | 8.2 | | | | | | | |
| | film 14 | | | | | | | | | |
| | Peeling | 60.0 | 8.2 | | | | | | | |
| | film 15 | | | | | | | | | |
| Protective | Protective | 25.0 | 2.7 | 0.2 | | | | | | |
| film | film 1 | | | | | | | | | |
| | Protective | 20.0 | 3.3 | | | | | | | |
| | film 2 | | | | | | | | | |
| | Protective | 5.0 | 5.7 | | | | | | | |
| | film 3 | | | | | | | | | |
| | Protective | 25.0 | 5.7 | | | | | | | |
| | film 4 | | | | | | | | | |
| | Protective | 40.0 | 5.7 | | | | | | | |
| | film 5 | | | | | | | | | |
| | Protective | 25.0 | 8.7 | 0.2 | | | | | | |
| | film 6 | | | | | | | | | |
| | Protective | 25.0 | 2.7 | 0.0 | ◯ | ◯ | ◯ | | | |
| | film 7 | | | | | | | | | |
| | Protective | 25.0 | 8.7 | 0.4 | | | | ◯ | ◯ | ◯ |
| | film 8 | | | | | | | | | |
| Polarizer | Polarizer 1 | 5.0 | 6.8 | | ◯ | ◯ | ◯ | ◯ | ◯ | ◯ |
| | Polarizer 2 | 15.0 | 6.8 | | | | | | | |
| | Polarizer 3 | 30.0 | 6.8 | | | | | | | |

Peeling films 1 to 15 shown in First table represent Peeling films 1 to 15 prepared as described above.

Protective films 1 to 8 shown in First table represent Protective films 1 to 8 prepared as described above. The humidity dimensional change of Protective film 1 is 0.2%, the humidity dimensional change of Protective film 6 is 0.2%, the humidity dimensional change of Protective film 7 is 0.0%, and the humidity dimensional change of Protective film 8 is 0.4%. Here, the humidity dimensional change is a humidity dimensional change in a direction in which curling occurs.

Polarizers 1 to 3 shown in First table represent Polarizers 1 to 3 prepared as described above.

<Evaluation of Curling Resistance>

The evaluation of curling resistance will be described below. First, a square with one side having a length of 10 cm is punched such that an absorption axis direction (MD direction) and a transmission axis direction (TD direction) of the obtained polarizing plate are set as diagonal lines to prepare a sample for evaluation. Next, the punched sample for evaluation is humidity-controlled at 25° C. and a relative humidity of 60% for 2 days and the curvature radius x (cm) of curling is measured. Then, the humidity is controlled at 25° C. and a relative humidity of 40% for 2 days and the curvature radius y (cm) of curling is measured. At this time, there is a possibility of curling occurring in both the MD and TD directions. However, the curvature radii in a direction in which the amount of curling is great are set to x and y. In addition, when the peeling film is curled inwardly, the mark of the curvature radius is made positive and when the peeling film is curled reversely, the mark of the curvature radius is made negative. Here, the intensity of curling is comparable based on the inverse of the curvature radius and it is important that a change in an environment at 25° C. and a relative humidity of 40% to 25° C. and a relative humidity of 60% is small during lamination not to cause lamination defects during lamination on an adherend such as a liquid crystal cell. A curling value was obtained from the following equation and curling resistance was evaluated based on the following evaluation criteria. The results are shown in Second table. A or B is preferable and A is more preferable for practical use.

Curling value=10/y−10/x

(Evaluation Criteria of Curling Resistance)
D: Less than −3.0 or more than 3.0
C: −3.0 or more and less than −2.5 or more than 2.5 and 3.0 or less
B: −2.5 or more and less than −2.0 or more than 2.0 and 2.5 or less
A: −2.0 or more and 2.0 or less

In Second table, the term “lower value of required thickness for peeling film [μm]” refers to a lower limit of a required thickness for the peeling film, which is calculated from the equation (A), in each of Examples and Comparative Examples. For example, in the cases of Comparative Example 2, and Examples 3 and 4, the thickness of the polarizer is 5.0 μmin and the thickness of the protective film is 25.0 μm. Thus, a lower limit of a required thickness for the peeling film is 34 [μm] (=2.8×5.0 [μm]−1.2×25.0 [μm]+50).

TABLE 6

| | | Comparative | Exam- | | Comparative | | | Comparative | | |
|---|---|---|---|---|---|---|---|---|---|---|
| Second table (Part 1) | | Example 1 | ple 1 | Example 2 | Example 2 | Example 3 | Example 4 | Example 3 | Example 5 | Example 6 |
| Peeling | Thickness | 40.0 | 60.0 | 80.0 | 20.0 | 40.0 | 60.0 | 50.0 | 70.0 | 90.0 |
| film | [μm] | | | | | | | | | |
| | Modulus of | 5.2 | | | 5.2 | | | 5.2 | | |
| | elasticity | | | | | | | | | |
| | [GPa] | | | | | | | | | |
| Protective | Thickness | 5.0 | | | 25.0 | | | 25.0 | | |
| film | [μm] | | | | | | | | | |
| | Modulus of | 5.7 | | | 5.7 | | | 5.7 | | |
| | elasticity | | | | | | | | | |
| | [GPa] | | | | | | | | | |
| | Humidity | — | | | — | | | — | | |
| | dimensional | | | | | | | | | |
| | change (%) | | | | | | | | | |
| Polarizer | Thickness | 5.0 | | | 5.0 | | | 15.0 | | |
| | [μm] | | | | | | | | | |
| | Modulus of | 6.8 | | | 6.8 | | | 6.8 | | |
| | elasticity | | | | | | | | | |
| | [GPa] | | | | | | | | | |
| Lower value of | | 58.0 | | | 34.0 | | | 62.0 | | |
| required thickness for | | | | | | | | | | |
| peeling film [μm] | | | | | | | | | | |
| Curling | Curling | −4.1 | −2.5 | −1.7 | −2.9 | −1.8 | −1.2 | −3.1 | −2.3 | −1.8 |
| resistance | value | | | | | | | | | |
| | Evaluation | D | B | A | C | A | A | D | B | A |

TABLE 7

| | | Comparative | | | Comparative | | Example |
|---|---|---|---|---|---|---|---|
| Second table (Part 2) | | Example 4 | Example 7 | Example 8 | Example 5 | Example 9 | 10 |
| Peeling | Thickness | 30.0 | 50.0 | 70.0 | 60.0 | 90.0 | 110.0 |
| film | [μm] | | | | | | |
| | Modulus of | 5.2 | | | 5.2 | | |
| | elasticity | | | | | | |
| | [GPa] | | | | | | |
| Protective | Thickness | 40.0 | | | 40.0 | | |
| film | [μm] | | | | | | |
| | Modulus of | 5.7 | | | 5.7 | | |
| | elasticity | | | | | | |
| | [GPa] | | | | | | |
| | Humidity | — | | | — | | |
| | dimensional | | | | | | |
| | change (%] | | | | | | |
| Polarizer | Thickness | 15.0 | | | 30.0 | | |
| | [μm] | | | | | | |
| | Modulus of | 6.8 | | | 6.8 | | |
| | elasticity | | | | | | |
| | [GPa] | | | | | | |
| Lower value of required | | 44.0 | | | 86.0 | | |
| thickness for peeling | | | | | | | |
| film [μm] | | | | | | | |
| Curling | Curling | −3.4 | −2.4 | −1.8 | −2.8 | −2.1 | −1.7 |
| resistance | value | | | | | | |
| | Evaluation | D | B | A | C | B | A |

TABLE 8

| | | Comparative | Example | Example | Comparative | Example | Example |
|---|---|---|---|---|---|---|---|
| Second table (Part 3) | | Example 6 | 11 | 12 | Example 7 | 13 | 14 |
| Peeling | Thickness | 20.0 | 40.0 | 60.0 | 20.0 | 40.0 | 60.0 |
| film | [μm] | | | | | | |
| | Modulus of | 2.2 | | | 8.2 | | |
| | elasticity [GPa] | | | | | | |
| Protective | Thickness | 25.0 | | | 25.0 | | |
| film | [μm] | | | | | | |
| | Modulus of | 5.7 | | | 5.7 | | |
| | elasticity [GPa] | | | | | | |
| | Humidity | — | | | — | | |
| | dimensional | | | | | | |
| | change (%) | | | | | | |
| Polarizer | Thickness | 5.0 | | | 5.0 | | |
| | [μm] | | | | | | |
| | Modulus of | 6.8 | | | 6.8 | | |
| | elasticity [GPa] | | | | | | |
| Lower value of required | | 34.0 | | | 34.0 | | |
| thickness for peeling film | | | | | | | |
| [μm] | | | | | | | |
| Curling | Curling value | −3.7 | −2.2 | −1.5 | −2.6 | −1.6 | −1.1 |
| resistance | Evaluation | D | B | A | C | A | A |

TABLE 9

| | | Comparative | Example | Example | Example | Example | Comparative | Example | Example |
|---|---|---|---|---|---|---|---|---|---|
| Second table (Part 4) | | Example 8 | 15 | 16 | 17 | 18 | Example 9 | 19 | 20 |
| Peeling | Thickness | 20.0 | 40.0 | 60.0 | 40.0 | 60.0 | 30.0 | 50.0 | 70.0 |
| film | [μm] | | | | | | | | |
| | Modulus of | 5.2 | | | 5.2 | | 5.2 | | |
| | elasticity | | | | | | | | |
| | [GPa] | | | | | | | | |
| Protective | Thickness | 25.0 | | | 25.0 | | 20.0 | | |
| film | [μm] | | | | | | | | |
| | Modulus of | 2.7 | | | 8.7 | | 3.3 | | |
| | elasticity | | | | | | | | |
| | [GPa] | | | | | | | | |
| | Humidity | 0.2 | | | 0.2 | | — | | |
| | dimensional | | | | | | | | |
| | change (%) | | | | | | | | |
| Polarizer | Thickness | 5.0 | | | 5.0 | | 5.0 | | |
| | [μm] | | | | | | | | |
| | Modulus of | 6.8 | | | 6.8 | | 6.8 | | |
| | elasticity | | | | | | | | |
| | [GPa] | | | | | | | | |
| Lower value of required | | 34.0 | | | 34.0 | | 40.0 | | |
| thickness for peeling film | | | | | | | | | |
| [μm] | | | | | | | | | |
| Curling | Curling value | −4.0 | −2.5 | −1.8 | −1.4 | −1.0 | −3.5 | −2.5 | −1.9 |
| resistance | Evaluation | D | B | A | A | A | D | B | A |

TABLE 10

| | | Comparative | Example | Example | Comparative | Example | Example |
|---|---|---|---|---|---|---|---|
| Second table (Part 5) | | Example 10 | 21 | 22 | Example 11 | 23 | 24 |
| Peeling | Thickness [μm] | 20.0 | 40.0 | 60.0 | 20.0 | 40.0 | 60.0 |
| film | Modulus of | 5.2 | | | 5.2 | | |
| | elasticity [GPa] | | | | | | |
| Protective | Thickness [μm] | 25.0 | | | 25.0 | | |
| film | Modulus of | 2.7 | | | 8.7 | | |
| | elasticity [GPa] | | | | | | |
| | Humidity | 0.0 | | | 0.4 | | |
| | dimensional | | | | | | |
| | change (%) | | | | | | |
| Polarizer | Thickness [μm] | 5.0 | | | 5.0 | | |
| | Modulus of | 6.8 | | | 6.8 | | |
| | elasticity [GPa] | | | | | | |
| Lower value of required | | 34.0 | | | 34.0 | | |
| thickness for peeling film | | | | | | | |
| [μm] | | | | | | | |
| Curling | Curling value | −2.6 | −1.6 | −1.1 | −3.1 | −1.9 | −1.4 |
| resistance | Evaluation | C | A | A | D | A | A |

As seen from Second table, all of Examples 1 to 24 exhibited excellent curling resistance.

In comparison between Examples 3 and 4, Examples 11 and 12, Examples 13 and 14, Examples 15 and 16, Examples 17 and 18, Examples 21 and 22, and Examples 23 and 24, Examples 4, 12, 14, 16, 18, 22, and 24 in which the thickness of the peeling film is 50.0 μm or more exhibited further excellent curling resistance.

In comparison among Examples 3, 11, and 13, and Examples 4, 12, and 14, Examples 3, 4, 13, and 14 in which the modulus of elasticity of the peeling film is 3.0 GPa or more exhibited further excellent curling resistance. Among these, Examples 13 and 14 in which the modulus of elasticity of the peeling film is 6.0 GPa or more exhibited even further excellent curling resistance.

In comparison between Examples 15 and 17, and Examples 16 and 18, Examples 17 and 18 in which the modulus of elasticity of the protective film is 3.0 GPa or more exhibited further excellent curling resistance.

In comparison between Examples 21 and 23, and Examples 22 and 24, Examples 21 and 22 in which the humidity dimensional change of the protective film is 0.2% or less exhibited further excellent curling resistance.

In comparison between Examples 1 and 4, Example 4 in which the thickness of the protective film is 10.0 μm or more exhibited further excellent curling resistance.

In comparison between Examples 5 and 8, Example 8 in which the thickness of the protective film is 30.0 μm or more exhibited further excellent curling resistance.

In comparison between Examples 4 and 5, Example 4 in which the thickness of the polarizer is 10.0 μm or less exhibited further excellent curling resistance.

In comparison between Examples 8 and 9, Example 8 in which the thickness of the polarizer is 20.0 μm or less exhibited further excellent curling resistance.

On the other hand, Comparative Examples 1 to 11 in which the thickness of the polarizer, the thickness of the protective film, and the thickness of the peeling film do not satisfy the equation (A) exhibited insufficient curling resistance.

<Production of Polarizing Plate Including Liquid Crystal Layer>

Regarding each polarizing plate of Examples 1 to 24 and Comparatives Examples 1 to 11 produced as described above, a polarizing plate including a liquid crystal layer, a polarizer, a protective film, an adhesive layer, and a peeling film in this order was produced by forming the liquid crystal layer on the principal surface opposite to the principal surface of the polarizer to which the protective film is attached. The curling resistance of the obtained polarizing plate was evaluated and thus the same result as shown in Second table was obtained.

### EXPLANATION OF REFERENCES

10: Polarizer
20: Protective film
30: Peeling film
40, 42: Adhesive layer
50, 52: Hard coat layer
60: Liquid crystal layer
70: Liquid crystal cell
100, 110, 120, 130, 140: Polarizing plate
200: Liquid crystal display device before peeling film and adhesive layer are peeled off
210: Liquid crystal display device after peeling film and adhesive layer are peeled off

What is claimed is:

1. A polarizing plate comprising, in this order:
a polarizer;
a protective film; and
a peeling film,
wherein a modulus of elasticity of the peeling film is 2.0 GPa or more, and
a thickness P [μm] of the polarizer, a thickness Q [μm] of the protective film, and a thickness T [μm] of the peeling film satisfy the following equation (A).
T≧(2.8×P−1.2×Q)+50 Equation (A)

2. The polarizing plate according to claim 1,
wherein the modulus of elasticity of the peeling film is 3.0 GPa or more.

3. The polarizing plate according to claim 1 further comprising:
a liquid crystal layer,
wherein the polarizing plate includes the liquid crystal layer, the polarizer, the protective film, and the peeling film in this order.

4. An image display device comprising:
the polarizing plate according to claim 1; and
a display element.

5. A liquid crystal display device comprising:
the polarizing plate according to claim 1; and
a liquid crystal cell.

6. The polarizing plate according to claim 2 further comprising:
a liquid crystal layer,
wherein the polarizing plate includes the liquid crystal layer, the polarizer, the protective film, and the peeling film in this order.

7. An image display device comprising:
the polarizing plate according to claim 2; and
a display element.

8. An image display device comprising:
the polarizing plate according to claim 3; and
a display element.

9. An image display device comprising:
the polarizing plate according to claim 6; and
a display element.

10. A liquid crystal display device comprising:
the polarizing plate according to claim 2; and
a liquid crystal cell.

11. A liquid crystal display device comprising:
the polarizing plate according to claim 3; and
a liquid crystal cell.

12. A liquid crystal display device comprising:
the polarizing plate according to claim 6; and
a liquid crystal cell.
